(19) United States
(12) Patent Application Publication
(10) Pub. No.: US 2004/0033342 A1
(43) Pub. Date: Feb. 19, 2004

(54) Material with ion formation capability

(76) Inventor: Kawaji Takimoto, Atsugi City (JP)

Correspondence Address: ROSENBERG, KLEIN & LEE, 3458 ELLICOTT CENTER DRIVE-SUITE 101, ELLICOTT CITY, MD, 21043, US

(21) Appl. No.: 10/216,932

(22) Filed: Aug. 13, 2002

(51) Int. Cl. B32B 1/00

(52) U.S. Cl. 428/148

(57) ABSTRACT

A kind of material with ion formation capability, characterized in which on a base made of synthetic or natural material, a thin film of adhesive layer is formed. Before said adhesive film is set, fine powder of natural radioactive rare earth element minerals are spread on top of it, and through which, fine powder of natural radioactive rare earth element minerals said base may be adhered to the surface of said base through the adhesive layer and exposed in the air to let the ions formed be released in the air. Those ions can help promote body metabolism and purify air.

### BACKGROUND OF THE INVENTION

1. Field of the Invention

The invention herein relates to a kind of material with ion formation capability that can effectively purify air and promote body metabolism.

2. Description of the Related Art

Porcelain with far infrared radioactivity has been used in health apparatus and products, so are materials with magnetic line of force.

Other materials have also been developed into basic material for health apparatus, particularly naturally radioactive rare earth elements which can create negative ion environment. These rare earth elements are known to be made into fine powder, to which liquid resin or melted resin is added. The resulting mixture is then painted on fabric or synthetic resin sheet or moulded into ion-producing health material.

As described, it is widely known that ion-producing naturally radioactive rare element may be used as health material. But conventional techniques entail no other than adding fine powder of rare element mineral to melted resin which is then made into certain shape by extrusion or injection, or adding fine powder of rare element mineral to liquid resin, which is then coated on fabric and set.

However the conventional techniques result in ion-producing rare element mineral being sealed in the resin layer, which tends to interfere with ion formation, hence defeating the purpose of adding the radioactive mineral. This is the biggest problem and shortcoming with conventional techniques.

### SUMMARY OF THE INVENTION

The objective of this invention is to address the problems encountered in materials with ion formation capability and to maximize the ion formation capability of natural radioactive rare-earth elements.

### BRIEF DESCRIPTION OF THE DRAWINGS

The objective, features and effect of the invention herein will become more apparent in the following detailed description of the preferred embodiments, with reference to the accompanying drawings below.

FIG. 1 is a magnified sectional drawing of a preferred embodiment of the invention herein.

### DETAILED DESCRIPTION OF THE PREFERRED EMBODIMENT

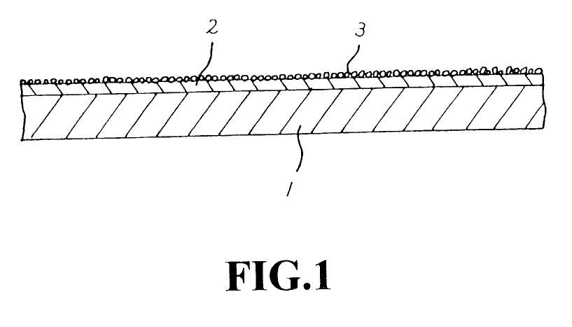

Referring to FIG. 1, the preferred embodiment of the invention herein consists of a base 1 made of synthetic or natural material, an adhesive layer 2 formed by coating a thin layer of adhesive on said base, and fine powder of natural radioactive rare earth element secured on the base 1 in high density through said adhesive layer 2.

The base 1 may be a sheet of natural fibre, synthetic fibre, synthetic resin or metal, or a board of synthetic resin, or natural wood panel. In essence, said base can come in any shape and material.

Naturally occurring radioactive rare earth element minerals are known to promote body metabolism and purify air with the formation of ions. Focusing on these characteristics of these kinds of rare earth element, this invention increases the surface area of such rare earth element mineral to maximize its ion formation capacity. To achieve that purpose, rare earth element minerals are made into fine powder with average particle size of 50 μm˜80 μm, and exposed on base 1 made of synthetic resin or thicker natural silk cotton. To secure the rare-earth element, a coat of adhesive is painted on the surface of said base to form an adhesive layer 2.

The adhesive layer 2 on the surface of base 1 sets with the progression of time. Before it is set, fine powders of naturally radioactive rare earth element 2 are spread on it, through which, the fine powders are fixed on the surface of base 1.

The adhesive coated on base 1 may be vinyl resin, such as poly (vinyl acetate), vinyl alcohol, and vinyl alkyl ether, or acrylic resin, such as tetraethyl lead acrylate, butyl methacrylate, and tetraethyl lead methacrylate, or phenol resin, urea resin, polyamide resin, polyester resin, epoxy resin, polyurethane resin, butadiene acrylonitrile rubber, butadiene styrene rubber, polychloroprene rubber, and any other adhesive that holds fine powder of natural radioactive rare earth elements well. In addition, to prevent the adhesive layer 2 made of any of the aforesaid adhesives from affecting the function of base 1, the coating of adhesive layer averages 30 μm˜150 μm in thickness.

The aforesaid naturally radioactive rare earth elements come in wide varieties, which may be used alone or in mixture of two or more kinds. If the fine powder of a rare earth element cannot hold onto the adhesive layer 2 on the surface of base 1, but piling on it instead, the powder may be recycled by simply turning base 1 over.

Under the influence of solar rays, charged ions of atoms in the air will lose an electron or draw an electron. It is widely known that negative ions in the air promote body metabolism and help clean air. As described, the material with ion formation capability of this invention features exposing fine powder of naturally radioactive rare earth element in the air, instead of sealing it in moulded material or adhesive. Thus all ions formed are released into the air, bringing about more pronounced effects of improved metabolism and air purification.

A practical application of the invention herein is, for example, small-sized air purifier. By placing the material with ion formation capability of this invention around the vent of airduct of the air purifier and inside its case, air drawn into the case by fan will be treated and added with ions before being discharged into the air through the vent. The material of this invention may also be applied to bedding, such as comfortable or pad to help improve the asthma condition during sleep and promote blood circulation.

The material with ion formation capacity of this invention may maximize the ion-producing effect of naturally radioactive rare earth element if it has the aforementioned structure, thus benefiting body metabolism and fresher air.

The description of the drawing above presents merely a preferred embodiment of this invention and is not meant to limit the applications of this invention. All modifications or equivalent variations in line with the spirit of this invention should be included in the claims of the invention herein.

1. A kind of material with ion formation capability, featuring coating a thin layer of adhesive on the surface of a base consisting of synthetic or natural material, and before the surface of said adhesive layer is set, spreading fine powder of naturally radioactive rare earth element that has the ion formation capability over it to let said fine powder of naturally radioactive rare earth element adhere to the surface of said base in high density through said adhesive layer;

2. A kind of material with ion formation capability as claimed in claim 1 in which the said base consisting of synthetic or natural material may be made into the shape of sheet or board.
